(19) United States
(12) Patent Application Publication
(10) Pub. No.: US 2006/0104073 A1
(43) Pub. Date: May 18, 2006

(54) Vehicle rear-view mirror having improved structure

(76) Inventor: Yung Lin Liang, Yung-Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/989,303

(22) Filed: Nov. 17, 2004

(51) Int. Cl. B60R 1/12; B60Q 1/26

(52) U.S. Cl. 362/494; 362/544; 362/509

(57) ABSTRACT

The present invention relates to a vehicle rear-view mirror having an improved structure. The present invention primarily comprises a casing having an opening inside which a mirror is mounted, wherein the casing comprises a first lampshade, mounted on a top portion of the casing, the first lampshade comprising a first lamp mounted therein and at least a transparent front wall and a transparent rear wall; and a second lampshade, mounted on a bottom portion of the casing, the second lampshade comprising a second lamp mounted therein and a third transparent wall faced in the same direction as the mirror; thereby the light emitted from the first lamp and the second lamp is able to penetrate through the first and second transparent walls of the first lampshade and the third transparent wall of the second lampshade respectively.

### FIELD OF THE INVENTION

The present invention relates to a vehicle rear-view mirror having an improved structure, and more particularly to a structure that enables other people in multi-positions to recognize the turning direction of the vehicle, wherein this structure is also used as auxiliary illumination for backing the vehicle.

### BACKGROUND OF THE INVENTION

Direction indicators of general vehicles are usually mounted on four corners of vehicle bodies and lower portions of vehicle doors. As a result of the visional blind spot caused by height limitation of a driver of a vehicle who is close to the other vehicle when these vehicles are in motion, this driver cannot realize that the other driver sat on the other vehicle intends to make a turn. For this reason, traffic accidents are usually caused. Moreover, a general driver usually depends on a reversing light that mounts behind the vehicle when he wants to park or back the vehicle on the roadside where provides with no external illumination or poor illumination during the night. However, the light emitted from the reversing light is merely confined to a region right behind the vehicle, it cannot illuminate every region that corresponds to the visional angle of the driver. Therefore, traffic accidents always occur when the driver parks or backs the vehicle during the night. For this reason, a few vehicles provide with a direction indicator on a central upper portion in the front of a casing of the rear-view mirror. In accordance with this design, however, only the vehicle that moves in a direction opposite to that of these vehicles is aware of this direction indicator and other vehicle that moves on the back or the side of these vehicles cannot see this direction indicator. Therefore, it cannot efficiently prevent the traffic accident from occurrence.

### SUMMARY OF THE INVENTION

In view of the aforementioned problems of the conventional technique, the present inventor devises a vehicle rear-view mirror having an improved structure. The main object of the present invention is to provide the combined designs of direction indicator warning light and auxiliary backing illumination for the vehicle.

According to the aforementioned object of the present invention, a vehicle rear-view mirror having an improved structure is provided. The vehicle rear-view mirror primarily comprises a casing having an opening inside which a mirror is mounted. It is worthy to note that the casing comprises a first lampshade, mounted on a top portion of the casing, the first lampshade comprising a first lamp mounted therein and at least a transparent front wall and a transparent rear wall; and a second lampshade, mounted on a bottom portion of the casing, the second lampshade comprising a second lamp mounted therein and a third transparent wall faced in the same direction as the mirror; thereby the light emitted from the first lamp and the second lamp is able to penetrate through the first and second transparent walls of the first lampshade and the third transparent wall of the second lampshade respectively.

The other features and preferred embodiments of the present invention will now be described with reference to the accompanying drawings.

### BRIEF DESCRIPTION OF THE DRAWINGS

FIG. 1 is a perspective view of the present invention.

FIG. 2 is a schematic view showing a first usage of the present invention.

FIG. 3 is a schematic view showing a second usage of the present invention.

### DETAILED DESCRIPTION OF THE PREFERRED EMBODIMENT

The content of the present invention will become more apparent for the examiners from the following detailed description when taken in conjunction with the accompanying drawings.

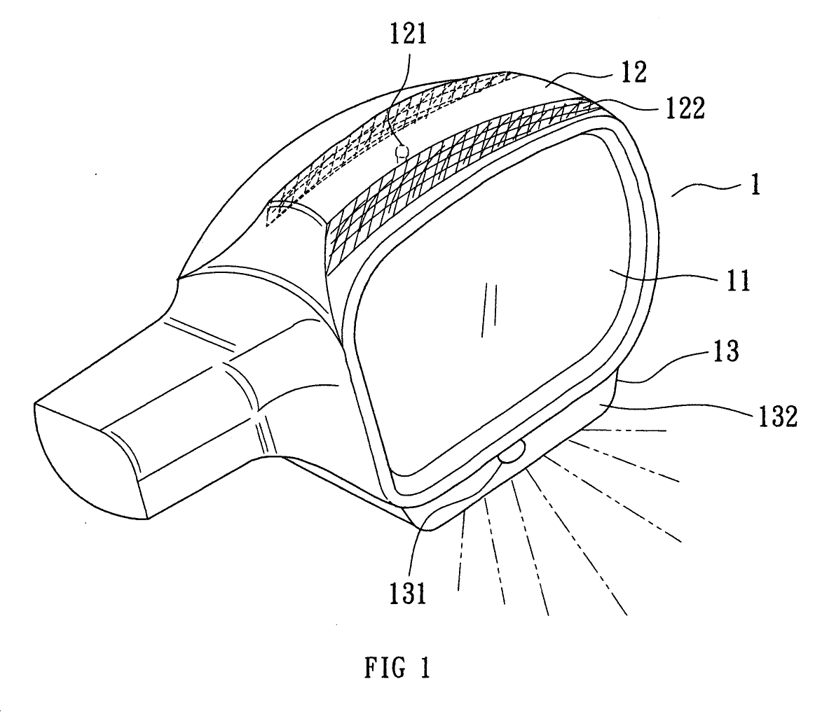

Referring to FIG. 1 through FIG. 3, the present invention relates to a vehicle rear-view mirror having an improved structure. The vehicle rear-view mirror primarily comprises a casing 1 having an opening inside which a mirror 11 is disposed.

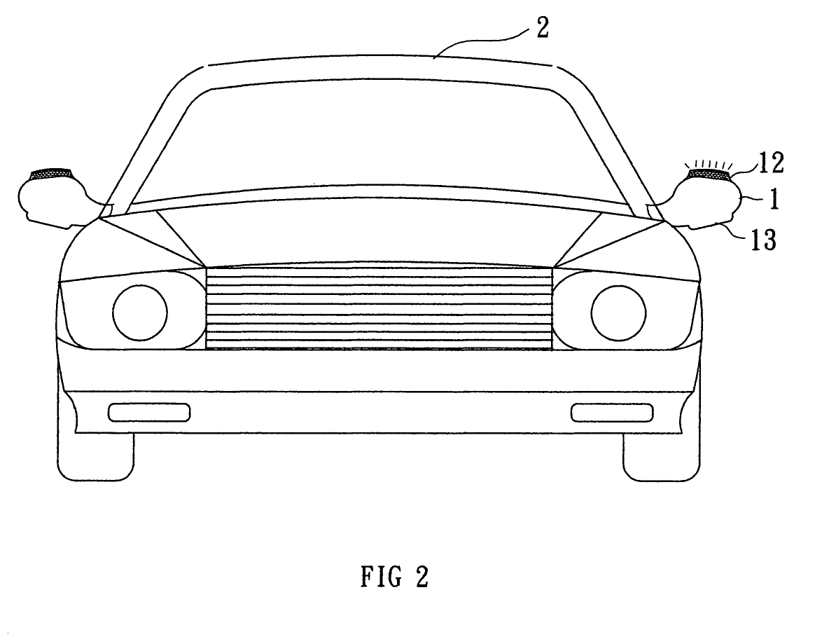

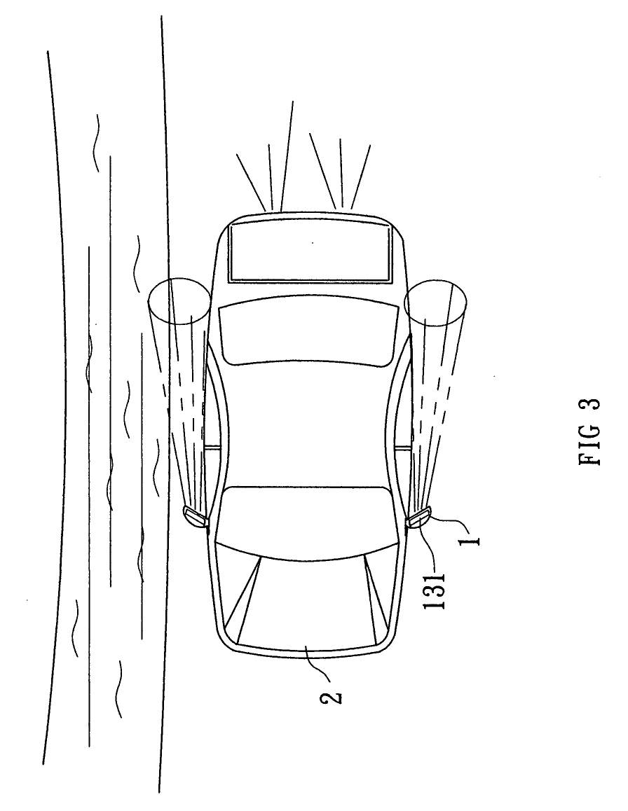

A first lampshade 12 is mounted on a top portion of the casing 1 and extended from thereof. The first lampshade 12 and the casing 1 are integrated into a unity. Alternatively, the first lampshade 12 is manufactured separately from the casing 1 followed by coupling the first lampshade 12 with the top portion of the casing 1 by use of a connection device. A first lamp 121 is disposed inside the first lampshade 12, wherein the first lampshade 12 at least comprises transparent front and rear walls 122. A second lampshade 13 is formed on a bottom portion of the casing 1 and extended from thereof. The second lampshade 13 and the casing 1 are integrated into a unity. Alternatively, the second lampshade 13 is manufactured separately from the casing 1 followed by coupling the second lampshade 13 with the bottom portion of the casing 1 by use of the connection device. A second lamp 131 is disposed inside the second lampshade 12, wherein a wall of the second lampshade 131 that faces in the same direction as the mirror 11 is a transparent wall 132. The first lamp 121 and the second lamp 131 are electrically connected to a power supply mounted on the vehicle for supplying the electric power for the first lamp 121 and the second lamp 131. Moreover, the first lamp 121 is able to emit the twinkling light when the vehicle makes a turn, as shown in FIG. 2. Moreover, the second lamp 131 emits a centralized light for projection on a rear tire of the vehicle 2 or a region nearby for use as auxiliary illumination for parking or backing the vehicle on the roadside during the night, as shown in FIG. 3.

Besides, it is able to adjust and control a light emitting angle of the second lamp 131 from the inside of the vehicle thereby achieving the purpose of improving the efficacy of illumination since it is free from blind spot.

In conclusion, the advantages and features of the present invention are listed as follows:

1. The present invention provides the combined designs of direction indicator warning light and auxiliary backing illumination for the vehicle so as to efficiently increase the traffic safety when the vehicle is in movement and the driver is parking or backing the vehicle on the roadside during the night.

2. The present invention is composed of simplified components, which are readily manufactured and assembled, such that the manufacture cost can be substantially reduced.

3. The light emitting angle of the second lamp can be adjusted and controlled from the inside of the vehicle thereby achieving and improving the efficacy of illumination since it is free from blind spot.

As described above, the present invention that satisfies requirements for patentability namely utility, novelty, and nonobviousness is submitted.

However, the above description merely illustrates the preferred embodiments of the present invention, and the applicable scope of the present invention is not limited hereto. Any obvious modification and revision made by a person skilled in the art are included within the spirit and scope of the present invention.

What the invention claimed is:

1. A vehicle rear-view mirror comprising:
a casing having an opening inside which a mirror is mounted, and the improvement comprises:
a first lampshade, mounted on a top portion of said casing, said first lampshade comprising a first lamp mounted therein and at least a transparent front wall and a transparent rear wall; and
a second lampshade, mounted on a bottom portion of said casing, said second lampshade comprising a second lamp mounted therein and a third transparent wall faced in the same direction as said mirror;
thereby the light emitted from said first lamp and the second lamp is able to penetrate through said first and second transparent walls of said first lampshade and said third transparent wall of said second lampshade respectively.

2. The vehicle rear-view mirror of claim 1, wherein said first lampshade and said second lampshade extend from said casing and integrate with said casing into a unity.

3. The vehicle rear-view mirror of claim 1, wherein said first lampshade and said second lampshade are manufactured separately from said casing followed by coupling said first lampshade and said second lampshade with said casing by use of a connection device.

4. The vehicle rear-view mirror of claim 1, wherein said first lampshade and said second lampshade are electrically connected with a power supply mounted on said vehicle.

5. The vehicle rear-view mirror of claim 1, wherein a light emitting angle of said second lampshade are controlled from the inside of said vehicle.
